(19) United States
(12) Patent Application Publication
(10) Pub. No.: US 2008/0084689 A1
(43) Pub. Date: Apr. 10, 2008

(54) Lighted balloon system

(76) Inventor: Allen D. Fletcher, Ojai, CA (US)

Correspondence Address: Friederichs Law Firm, 6421 Kurtz Lane, Eden Prairie, MN, 55346-1609, US

(21) Appl. No.: 11/545,147

(22) Filed: Oct. 10, 2006

(51) Int. Cl. F21L 4/02

(52) U.S. Cl. 362/184

(57) ABSTRACT

A combination including an electrical source, a light emitting mechanism, a balloon communicating with the electrical source and serving as a one conductor of the electricity, another electrical conduit communicating with the electrical source and serving as the other conductor of the electricity, the balloon providing a decoration.

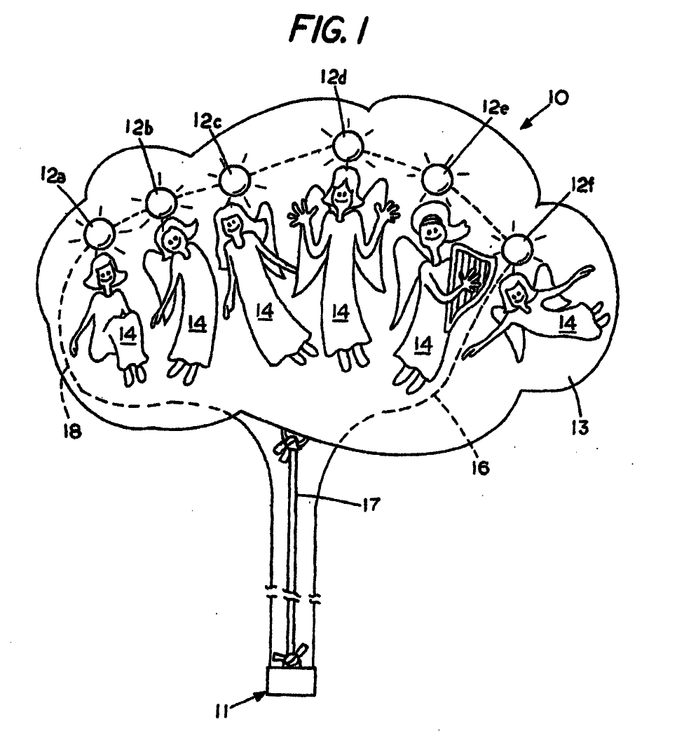

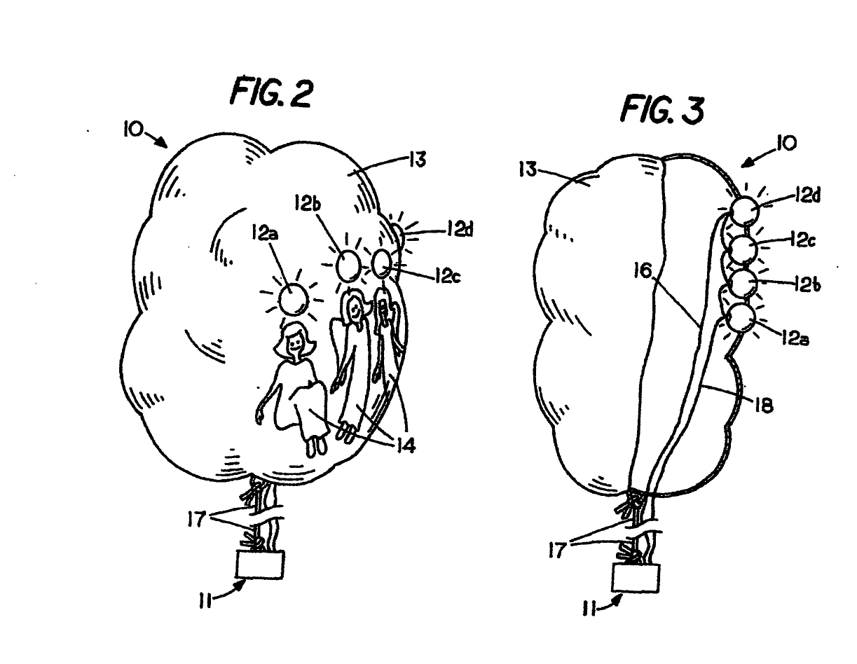

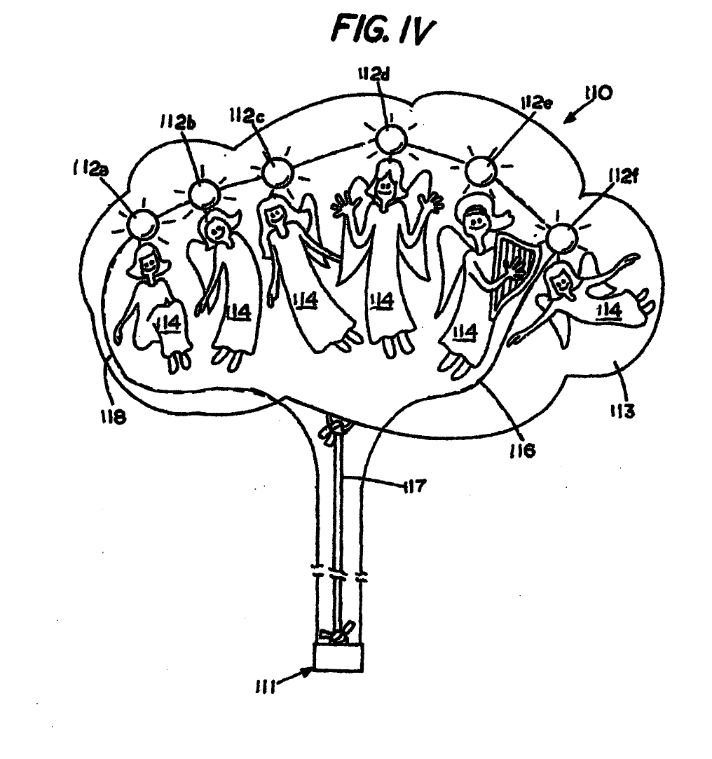

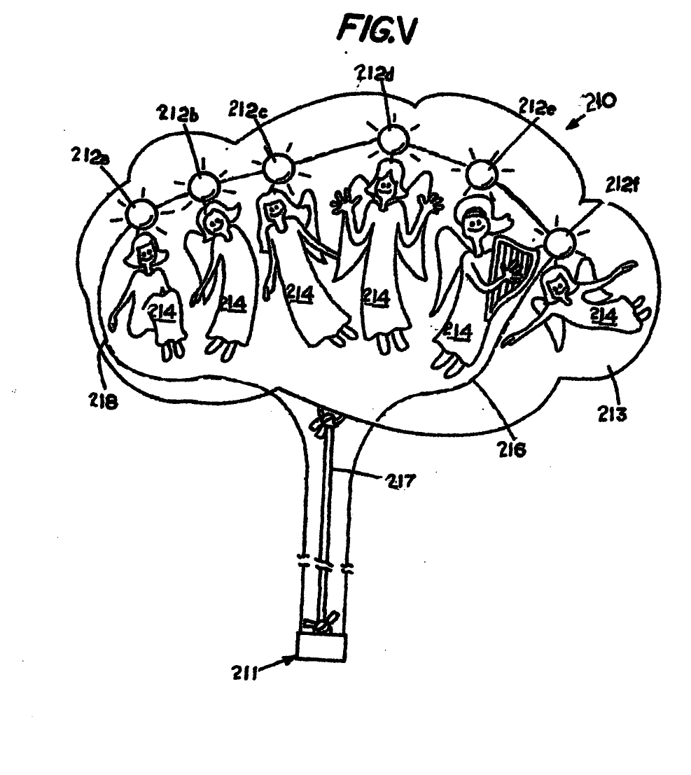

### THE FIELD OF THE PRESENT INVENTION

The present invention relates to decorative balloons.

### THE PRESENT INVENTION

The present invention relates to a balloon and more particularly a lighted decorative balloon.

### BACKGROUND OF THE PRESENT INVENTION

It is known in the prior art to illuminate balloons. The patent entitled ILLUMINATED FIBER DECORATED BALLOONS to Zingale et al (U.S. Pat. No. 6,371,638) discloses an inflatable translucent balloon body with a lifting force having a light transmitting tether and power pack attached thereto to an end opposite the balloon. The tether has a weight less than the lifting force. However, Zingale et al reference does illustrate a mylar balloon, LED lights, lights attached to the exterior of the balloon.

The patent entitled ILLUMINATION SYSTEM FOR BALLOONS WITH THIN FILM VALVES to Sussell (U.S. Pat. No. 5,192,332 has been provided as another example of an invention of lighted balloon. Sussell discloses a mylar balloon with incandescent light bulbs placed inside the balloon.

The patent entitled TOY WITH BALLOON AND LIGHTING APPARATUS to Bertrand (U.S. Pat. No. 6,390,651) has been provided as another example of an invention that is related to the LIGHTED BALLOON. Bertrand shows a lighted balloon with the light disposed on the outside of the balloon.

The prior art fails to show a system in which the balloon itself is the conducter of the electricity. What is needed is a balloon being lighter in weight than prior similar balloons using only the printed circuit conductor for conducting electricity rather than the traditional two wires.

### SUMMARY OF THE PRESENT INVENTION

The present invention is the combination including an electrical source, a light emitting mechanism, an electrically lighted balloon. The balloon is constructed of a film . The light emitting mechanism is connected with the electrical source by printed circuit applied to the surface of the balloon. The printed circuit on the balloon conducts the electricity and feeds the electricity from the electrical source to the light emitting mechanism. The balloon provides a lighted decoration. An advantage of the present invention is that the balloon itself is the two conductors of electricity rather than wire.

### IN THE FIGURES

FIG. I is a front plan view of the present invention;

FIG. II is a front perspective view of the present invention;

FIG. III is a vertical side view with portions broken away;

FIG. IV is a front plan view of the second embodiment of the present invention;

FIG. V is a front plan view of the third embodiment of the present invention;

### DETAILED DESCRIPTION

The lighted balloon system 10 is electrically supported by a battery 11. The battery preferably is a dry cell, such as a 6 volt, 9 volt or a 12 volt. The system 10 has at least one electrically powered light source 12. The light source may be any type of light such as LED or incandescent light bulb. System 10 may have as many such light sources as desired, such 12a, 12b, 12c, 12d, 12e. The light sources 12 are supported on the balloon 13. The light sources 12 may be inside or outside the balloon 13. The balloon 13 may have any desired shape. For example, the shape of balloon 13 may be aesthetically pleasing in shape, i.e. having the appearance of back ground clouds with a foreground of angel characters 14.

The light sources 12 may be on the external side of balloon 13 so that light is reflected from the outer surface of balloon 13 which may carry a decorative design 14. The design may be for example angels 14. The interior surface of the balloon 13 may carry an electrically conductive printed circuit material, ie., conduit 16; the printed circuit a layer of the laminate, such as MYLAR®, METAL COATED NYLON®. The return conduit is designated 18. Alternatively, the light sources 12 5 may be on the inside of the balloon 13, in which case the balloon 13 would be made of an electrically conductive transparent material, such as metal coated nylon on the inside of the balloon as a printed circuit 15. The light source may shine so that it reflects on the surface of the balloon 13 or alternatively through the balloon surface. The system 10 has another conduit 18, which may be a continuous path of metalised coating. The balloon 13 may be connected in to the tether 17. The light sources 12 may be any type of light such as LED or incandescent light bulb. System 10 may have as many such light sources 12 as desired connected either in series or in parallel.

In a second embodiment shown in FIGURE IV, the lighted balloon system 110 is electrically supported by a battery 111. The battery preferably is a dry cell, such as a 6 volt, 9 volt or a 12 volt. The system 110 has at least one electrically powered light source 112. The light source may be any type of light such as LED or incandescent light bulb. System 110 may have as many such light sources as desired, such 112a, 112b, 112c, 112d, 112e and 112f. The light sources 112 are supported on the balloon 113. The light sources 112 may be inside or outside the balloon 113. The balloon 113 may have any desired shape. For example, the shape of balloon 113 may be aesthetically pleasing in shape i.e. having the appearance of back ground clouds with a foreground of angel characters 114.

The light sources 112 may be on the external side of balloon 113 so that light is reflected from the outer surface of balloon 113 which may carry a decorative design 114. The design may be for example angels 114. The exterior surface of the balloon 113 may carry electrical conducting material printed on the surface of said balloon, ie., electrical conduit 116; the printed circuit a layer of the laminate, such as MYLAR®, METAL COATED NYLON®. The return conduit is designated 118. Alternatively, the light sources 112 may be on the inside of the balloon 113, in which case the balloon 113 would be made of an electrically conductive transparent material, such as metal coated nylon on the outside of the balloon as a printed circuit 115. The light source may shine so that it reflects on the surface of the balloon 113 or alternatively through the balloon surface. The system 110 has another conduit 118, which may be a wire. The balloon 113 may be connected in to the tether 117. The light sources 112 may be any type of light such as LED or incandescent light bulb. System 110 may have as many such light sources 112 as desired connected either in series or in parallel.

In a third embodiment shown in FIG. V, the lighted balloon system 210 is electrically supported by a battery 11. The battery preferably is a dry cell, such as a 6 volt, 9 volt or a 12 volt. The system 210 has at least one electrically powered light source 212. The light source may be any type of light such as LED or incandescent light bulb. System 210 may have as many such light sources as desired, such 212a, 212b, 212c, 212d, 212e and 212f. The light sources 212 are supported on the balloon 213. The light sources 212 may be inside or outside the balloon 213. The balloon 213 may have any desired shape. For example, the shape of balloon 213 may be aesthetically pleasing in shape, i.e. having the appearance of back ground clouds with a foreground of angel characters 214.

The light sources 212 may be on the external side of balloon 213 so that light is reflected from the outer surface of balloon 213 which may carry a decorative design 214. The design may be for example angels 214. The exterior surface of the balloon 213 may carry a wire, ie., conduit 216. The return conduit is designated 218. Alternatively, the light sources 212 may be on the inside of the balloon 213, in which case the balloon 213 would be made of an electrically conductive transparent material, such as metal coated nylon on the inside of the balloon as a printed circuit 215. The light source may shine so that it reflects on the surface of the balloon 213 or alternatively through the balloon surface. The system 210 has another conduit 218, which may be a continuous wire. The balloon 213 may be connected in to the tether 217. The light sources 212 may be any type of light such as LED or incandescent light bulb. System 210 may have as many such light sources 212 as desired connected either in series or in parallel.

### OPERATION

Although the operation of the present invention 10 is apparent from the preceeding disclosure, it will further discribed hereinafter. The battery 11 passes electricity to the printed circuit 16 on the balloon 13 to the light emitting mechanism 12. The other electrical conduit 18 passes the electricity from the light source 12 directly back to the battery 11.

The present invention is described in specific details. It should be recognised that it is within the skill of the art that modifications can be made within the breadth of the claims.

What is claimed is:

1. The combination comprising a battery, at least one electrically powered light source, a balloon, said balloon is constructed of film material having a surface and a electrical conducting material printed on the surface of said balloon and providing electrical communication between said battery, providing a decoration through the shape and the surface of said balloon, so positioned as to accentuate the decoration by shining on said decoration.

2. The combination comprising an electrical source, a light emitting means, a balloon communicating with the electrical source and serving as a one conductor of the electricity, another electrical conduit communicating with the electrical source and serving as the other conductor of the electricity, said balloon providing a decoration.

3. The combination of claim 2; wherein, said second mentioned conductor of the electricity comprises a wire.

4. The combination of claim 2; wherein, the shape of said balloon provides said decoration.

5. The combination of claim 4; wherein, the surface of said balloon provides said decoration.

6. The combination of claim 4; wherein, said electrical source comprises a battery.

7. The combination of claim 4; wherein, said balloon is constructed of electrical non-conducting material.

8. The combination of claim 4; wherein, said light emitting source is at least one electric light bulb.

9. The combination of claim 8; wherein, said light emitting source is a plurality of electric light bulbs.

10. The combination of claim 9; wherein, said plurality of electric light bulbs are so positioned as to accentuate the decoration.

11. The combination of claim 10; wherein, said plurality of electric light bulbs are so positioned as to accentuate the decoration by back lighting said decoration.

12. The combination of claim 11; wherein, said plurality of electric light bulbs are so positioned as to accentuate the decoration by back lighting said decoration and shining through the decoration.

13. The combination comprising a balloon, a light emitting source powered by an electrical source and electrical conduit carrying the first of two said pair of electrical sources, said conduit being in electrical engagement with said light emitting source, said balloon being electrically conductive and carrying the other source of electricity.

14. The combination of claim 13; wherein, said balloon is constructed of electrical conducting material.

15. The combination of claim 14; wherein, said electrical source comprises a battery.

16. The combination of claim 15; wherein, said second mentioned conductor of the electricity consists of a wire.

17. The combination of claim 16; wherein, said light emitting source is a plurality of LEDs.

18. The combination of claim 17; wherein, said plurality of LEDs are so positioned as to accentuate the decoration by back lighting said decoration and shining through the decoration.
